(19) United States
(12) Patent Application Publication
(10) Pub. No.: US 2008/0026889 A1
(43) Pub. Date: Jan. 31, 2008

(54) Speed change device of a bicycle

(76) Inventor: Douglas Chiang, Taichung (TW)

Correspondence Address: DOUGLAS CHANG, 235 Chung-Ho, Box 8-24, Taichung, omitted

(21) Appl. No.: 11/495,698

(22) Filed: Jul. 31, 2006

(51) Int. Cl. F16H 63/00; F16H 59/00

(52) U.S. Cl. 474/80

(57) ABSTRACT

A speed change device of a bicycle comprises a body having a ring clamping portion and a driven portion; the driven portion being connected to a chain driving sheet; an L shape driven arm pivoted to the body; one end of the driven arm being installed with a connecting portion; and another end thereof being installed with a pivot portion; the pivot portion being pivoted to the chain driving sheet; wherein the chain driving sheet is driven by the driven arm to achieve the object of moving a chain received in the chain driving sheet and to change speed of a bicycle. A bending portion of the L shape driven arm has a cambered shape. The connecting portion of the driven arm receives a speed change rope.

### FIELD OF THE INVENTION

The present invention relates to speed change device, in particular to a speed change device of a bicycle, which need less power to control the speed change device and the wear of the speed change device is reduced greatly as compared with the prior art.

### BACKGROUND OF THE INVENTION

The speed change device of a bicycle is formed by a main gear coaxially with the treadle and a plurality of driven gears coaxially with the rear wheel. The driven gears are coaxial and have different diameters. A chain serves to connect the main gear and driven gears so that the main gear can be connected to one of the driven gears. Thus by switching the chain to different driven gear, the speed of the bicycle is changed.

A speed change device is assembled to change the relation of the chain and the gears. One of the prior art related to the speed change device is U.S. Pat. No. 5,607,367. In the prior art, an adjuster is installed on a handle of a bicycle. The adjuster is interacted with the speed change device through a speed change rope. The user can adjust the adjuster to the pull or release the speed change device. When the speed change device is pulled, a push rod having a spring in the speed change device will move away from the chain driving sheet. Then the chain driving sheet drives the chain to a great gear. On the contrary, when the speed change rope is released, the push rod will be reduced inward by the action of the spring, the chain will reduce inwards. Thus the chain will pull back to a small gear. Thus, the chain can be engaged with different gear to change the speed of the bicycle.

In this prior art, the pulling direction of speed change rope is vertical to the push rod so that some undesired friction force is generated and thus the push rod and the chain driving sheet can not effectively change the pull force of the speed change rope into the push force of the chain driving sheet. Thus, the control of speed change is not inconvenient. When a great force is needed, especially in fast speed, the tension force of the chain is great. It is difficult to control the change of the speed. Thereby the elements are easy to wear. As a whole, the prior art is impractical and necessary to be improved.

### SUMMARY OF THE INVENTION

Accordingly, the primary object of the present invention is to provide a speed change device of a bicycle, which need less power to control the speed change device and the wear of the speed change device is reduced greatly as compared with the prior art.

To achieve above objects, the present invention provides a speed change device of a bicycle. The speed change device comprises a body having a ring clamping portion and a driven portion; the driven portion being connected to a chain driving sheet; an L shape driven arm pivoted to the body; one end of the driven arm being installed with a connecting portion; and another end thereof being installed with a pivot portion; the pivot portion being pivoted to the chain driving sheet; wherein the chain driving sheet is driven by the driven arm to achieve the object of moving a chain received the chain driving sheet and to change speed of a bicycle. A bending portion of the L shape driven arm has a cambered shape. The connecting portion of the driven arm receives a speed change rope. A center of the driven arm has a pivot shaft which is pivoted to the body, and the driven arm is rotatably combined to the body. The ring clamping portion serves to clamp a rod structure of a bicycle. The chain driving sheet has a recess for receiving a chain. An elastic unit encloses the pivot shaft.

The various objects and advantages of the present invention will be more readily understood from the following detailed description when read in conjunction with the appended drawing.

### BRIEF DESCRIPTION OF THE DRAWINGS

FIG. 1 is an exploded perspective view of the speed change device of the present invention.

FIG. 2 is a perspective view of the speed change device of a bicycle of the present invention.

FIG. 3 is an assembled schematic view of the speed change device of a bicycle of the present invention.

FIGS. 4 and 5 are schematic views about the speed change device of a bicycle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

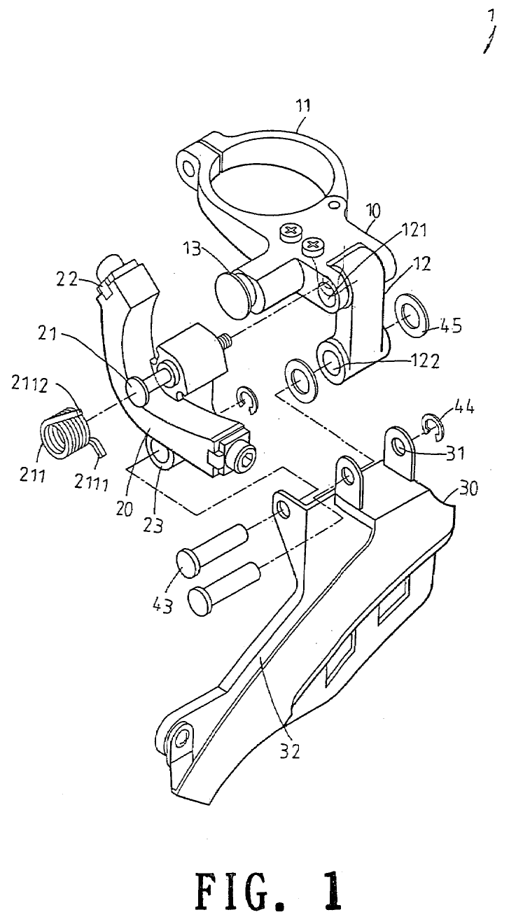

Referring to FIGS. 1 to 3, the bicycle gear change device of the present invention is illustrated. The device can be assembled to a rod structure 41 of a bicycle 40 so as to be controlled by an adjustor (not shown) to achieve the object of changing the chain and thus changing speed of the bicycle.

The present invention has the following elements.

A body 10 is formed by a clamping portion 11 at one end thereof. The clamping portion 11 has a form of a ring so as to be assembled to the rod structure 41 of a bicycle 40 to combine the speed change device 1 to the bicycle 40. Another end of the body 10 is formed with a driven portion 12 which has a form of a rod. One end of the driven portion 12 has a first pivotal end 121 which is pivoted to the body 10 so that the first pivotal end 121 is rotatable with respective to the body 10. Another end of the driven portion 12 has a second pivotal end 122 which is pivoted to a chain driving sheet 30 so that the chain driving sheet 30 is rotatable with respective to the body 10 with the driven portion 12. A center of the body 10 is formed with a resisting portion 13.

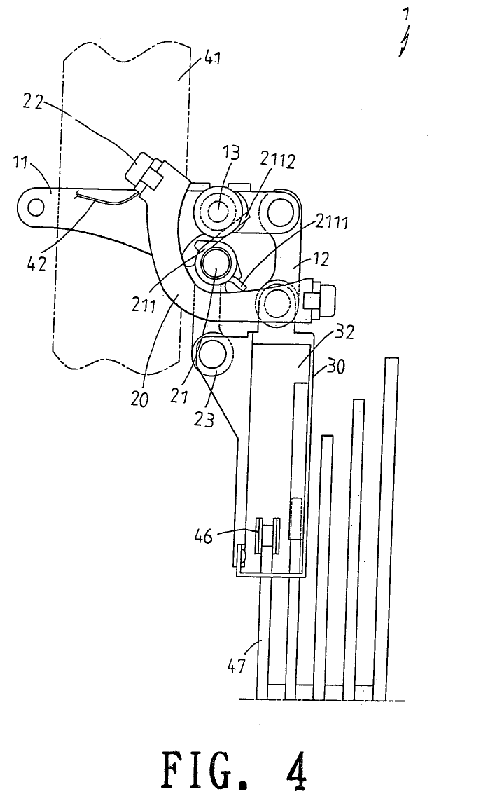

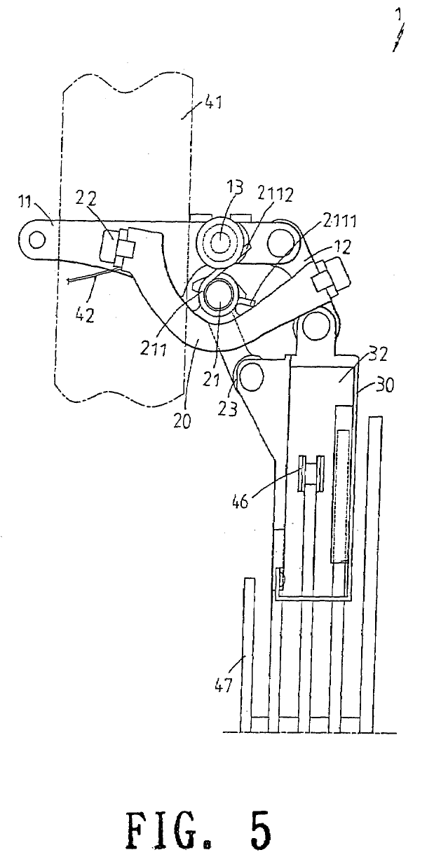

A driven arm 20 is formed with an L shape. A bending area of the L shape driven arm 20 is formed with a cambered shape. A bending area of the driven portion 12 is installed with a pivot shaft 21 which can passes through the first pivotal end 121 of the body 10 so as to combine the body 10, driven portion 12 and driven arm 20 so that the whole structure is rotatable. An elastic unit 211 encloses the pivot shaft 21 of the driven arm 20. The elastic unit 211 may be a twisting spring. Two ends of the elastic unit 211 are a first end 2111 and a second end 2112. The first end 2111 resists against the driven arm 20 and the second end 2112 resists against the resisting portion 13 of the body 10. One end of the L shape driven arm 20 is formed with a connecting portion 22 for assembling a speed change rope 42 (referring to FIGS. 4 and 5). Another end of the L shape driven arm 20 is installed with a pivot portion 23. By using pivot units 44 to pass through holes of the pivot portion 23 and pivot holes 31 of the chain driving sheet 30 and a C ring 44, the pivot portion 23 is assembled to the chain driving sheet 30.

The chain driving sheet 30 has two sets of pivot holes 31 for combining the second pivotal end 122 of the driven portion 12 and the pivot portion 23. The chain driving sheet 30 has a cambered recess 32 for receiving a chain 46. Therefore, when the chain driving sheet 30 moves transversally, the chain 46 is driven to move.

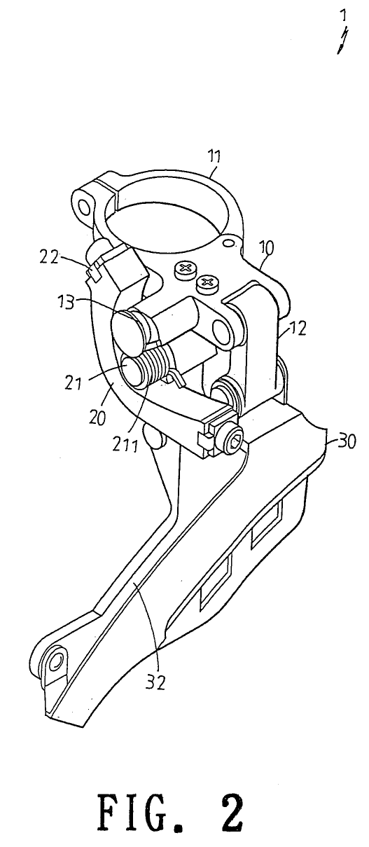

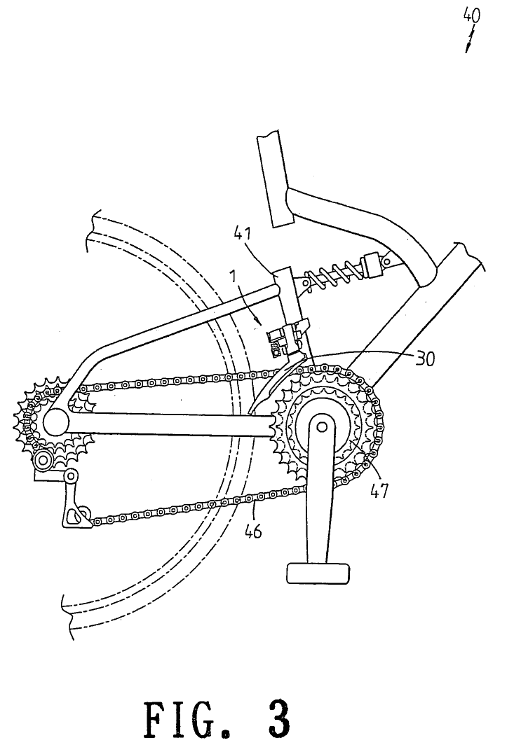

With reference to FIGS. 2 and 3, an assembly view of the present invention is illustrated, where the present invention is assembled to a bicycle 40. The speed change device 1 is combined with a body 10 by the clamping portion 11 thereof. The chain 46 passes through the recess 32 of the chain driving sheet 30. The chain driving sheet 30 is driven by the driven arm 20 so as to drive the chain 46 to achieve the object of speed change.

In use of the present invention, referring to FIGS. 4 and 5, the connecting portion 22 of the driven arm 20 is combined to a speed change rope 42. When an adjuster (not shown) is adjusted by the user, the speed change rope 42 will pull or release the driven arm 20.

Referring to FIG. 4, if the speed change rope 42 is released to a loose state, the driven arm 20 is affected by the elastic force of the elastic unit 211 and thus will drive the chain driving sheet 30 to move inwards. The chain 46 in the recess 32 of the chain driving sheet 30 will move to a small gear 47 therewith.

Referring to FIG. 5, if the speed change rope 42 is tightened, the driven arm 20 is pulled by the speed change rope 42 so that the chain driving sheet 30 move outwards to cause that the chain 46 in the recess 32 of the chain driving sheet 30 to move to a great gear 47. Furthermore, since the first end 2111 and second end 2112 of the elastic unit 211 enclosing the pivot shaft 21 of the driven arm 20 resists against the driven arm 20 and the resisting portion 13, the elastic unit 211 will be compressed to store energy until the speed change rope 42 is adjusted to a loose position. Then the elastic unit 211 will pull the driven arm 20 and the chain driving sheet 30 inwards.

By above mentioned structure, the user can adjust the chain driving sheet 30 through the adjuster and the speed change rope 42. Since the driven arm 20 has an L shape and a cambered bending portion, the pulling force of the chain 46 can be effectively transferred to the chain driving sheet 30 to avoid the power lose from the chain 46 and the chain driving sheet 30. Thus power is saved and the friction is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A speed change device of a bicycle, comprising:
a body having a ring clamping portion and a driven portion; the driven portion being connected to a chain driving sheet;
an L shape driven arm pivoted to the body; one end of the driven arm being installed with a connecting portion; and another end thereof being installed with a pivot portion; the pivot portion being pivoted to the chain driving sheet;
wherein the chain driving sheet is driven by the driven arm to achieve the object of moving a chain received in the chain driving sheet and to change speed of a bicycle.

2. The speed change device of a bicycle as claimed in claim 1, wherein a bending portion of the L shape driven arm has a cambered shape.

3. The speed change device of a bicycle as claimed in claim 1, wherein the connecting portion of the driven arm receives a speed change rope.

4. The speed change device of a bicycle as claimed in claim 1, wherein a center of the driven arm has a pivot shaft which is pivoted to the body, and the driven arm is rotatably combined to the body.

5. The speed change device of a bicycle as claimed in claim 1, wherein the ring clamping portion serves to clamp a rod structure of a bicycle.

6. The speed change device of a bicycle as claimed in claim 1, wherein the chain driving sheet has a recess for receiving a chain.

7. The speed change device of a bicycle as claimed in claim 1, wherein an elastic unit encloses the pivot shaft.
